(19) United States
(12) Patent Application Publication
(10) Pub. No.: US 2013/0040167 A1
(43) Pub. Date: Feb. 14, 2013

(54) PERPENDICULAR MAGNETIC RECORDING MEDIUM AND ITS MANUFACTURING METHOD

(71) Applicants: Perumal Alagarsamy, Ibaraki (JP); Yukiko Takahashi, Ibaraki (JP); Kazuhiro Hono, Ibaraki (JP); Tomoko Seki, San Jose, CA (US)

(72) Inventors: Perumal Alagarsamy, Ibaraki (JP); Yukiko Takahashi, Ibaraki (JP); Kazuhiro Hono, Ibaraki (JP); Tomoko Seki, San Jose, CA (US)

(73) Assignees: WD MEDIA (SINGAPORE) PTE. LTD., Irvine, CA (US); NATIONAL INSTITUTE FOR MATERIALS SCIENCE, Tsukuba-shi, Ibaraki (JP)

(21) Appl. No.: 13/522,261

(22) PCT Filed: Jan. 12, 2011
(86) PCT No.: PCT/JP2011/050316

§ 371 Date: Oct. 22, 2012

(30) Foreign Application Priority Data
Jan. 14, 2010 (JP) 2010-005598

(51) Int. Cl. G11B 5/738; G11B 5/851; G11B 5/667

(52) U.S. Cl. 428/831.2; 428/831; 427/131

(57) ABSTRACT

It is aimed to provide a perpendicular magnetic recording medium capable of dealing with an ultra-higher recording density than before and its manufacturing method.

The present invention concerns a perpendicular magnetic recording medium including at least a seed layer made of noncrystalline ceramic, a crystalline orientation control layer and a magnetic layer made of a material mainly containing a FePt alloy in this order on a substrate. This perpendicular magnetic recording medium is suitably manufactured by forming at least the seed layer, the orientation control layer and the magnetic layer made of the material mainly containing the FePt alloy in this order on the substrate by sputtering, wherein the magnetic layer is formed at a predetermined temperature of 500° C. or less.

### TECHNICAL FIELD

The present invention relates to a perpendicular magnetic recording medium such as a magnetic disk to be loaded into a perpendicular magnetic recording type magnetic disk device such as a hard disk drive (hereinafter, arbitrarily abbreviated as “HDD”) and its manufacturing method.

### BACKGROUND ART

Various information recording technologies have been developed as information processing capacities have increased in recent years. Particularly, a surface recording density of HDDs and the like using a magnetic recording technology continues to increase at an annual rate of about 100%. Lately, information recording capacity exceeding 500 G bytes per disk has been required for magnetic disks with a diameter of 2.5 inches used for HDDs and the like. To meet such a request, it is required to realize an information recording density exceeding 720 G bits per 1 inch². To attain a high recording density in a magnetic disk used for HDDs and the like, it has been necessary to refine magnetic crystal particles constituting a magnetic recording layer for recording information signals and reduce the thickness of the magnetic recording layer. However, in the case of a magnetic disk employing a conventionally commercialized in-plane magnetic recording method (also called longitudinal magnetic recording method or horizontal magnetic recording method), a development of refinement of crystal particles has resulted in a thermal instability phenomenon in which thermal stability of recording signals is impaired due to a superparamagnetic phenomenon and, hence, the recording signals are lost, which has become an obstructive factor to a higher recording density of magnetic disks.

To solve this obstructive factor, magnetic disks for the perpendicular magnetic recording method have been proposed in recent years. In the case of the perpendicular magnetic recording method, an axis of easy magnetization of a magnetic recording layer is adjusted to be oriented in a direction perpendicular to a substrate surface unlike in the case of the in-plane magnetic recording method. Since the perpendicular magnetic recording method can suppress the thermal instability phenomenon more as compared with the in-plane magnetic recording method, it is suitable for a higher recording density. For example, Japanese Unexamined Patent Publication No. 2002-92865 (patent document 1) discloses a technology relating to a perpendicular magnetic recording medium manufactured by forming a soft magnetic layer, an underlayer, a Co-containing perpendicular magnetic recording layer, a protective layer and the like on a substrate in this order. Further, the specification of U.S. Pat. No. 6,468,670 (patent document 2) discloses a perpendicular magnetic recording medium with such a structure in which an exchange-coupled artificial lattice film continuous layer (exchange-coupled layer) is attached to a granular recording layer.

However, a request to increase the information recording capacity is ever rising and it is at present required to further increase the recording density of perpendicular magnetic recording media.

For example, discrete track media (DTMs) and bit patterned media (BPMs) in which side fringe between adjacent tracks and between adjacent bits is reduced by magnetically separating data tracks and bits are expected to be next-generation (or next-next-generation) perpendicular magnetic recording media.

The appearance of such a recording method as to be able to attain an ultra-high recording density exceeding an information recording density by the perpendicular magnetic recording method is hoped for, and thermally assisted magnetic recording is drawing attention as one means for that. Since this thermally assisted magnetic recording enables recording and reproduction on and from high coercivity media with high resistance to such thermal instability with which no recording can be made by conventional magnetic recording methods, it is expected to attain an ultra-high recording density exceeding an information recording density by the conventional perpendicular magnetic recording method.

To attain an information recording density beyond, for example, 1 terabit per inch² exceeding the information recording density of present perpendicular magnetic recording media, it is necessary not only to improve the recording method as described above, but also to improve a ferromagnetic material constituting magnetic recording media. For example, in a magnetic recording medium with an ultra-high recording density beyond 1 terabit per inch², a bit size as a recording unit has to be made even smaller, wherefore a thermal instability problem of magnetic particles arises again. To ensure thermal stability (resistance to thermal instability) against this problem, it becomes necessary to increase anisotropy energy which compensates for a volumetric reduction of the magnetic particles accompanying the refinement of the magnetic particles. For example, it has been proposed to use a magnetic material having a high crystal magnetic anisotropy constant (Ku) of 5×10⁷ erg/cc or higher such as FePt with an L1o structure for a granular magnetic layer (for example, patent document 3). Note that it is difficult to obtain a high Ku in the order of 10⁷ with conventional CoCrPt-containing magnetic materials.

### CITATION LIST

### Patent Literature

### Patent Document 1:

Japanese Unexamined Patent Publication No. 2002-92865

### Patent Document 2:

Specification of U.S. Pat. No. 6468670

### Patent Document 3:

Japanese Unexamined Patent Publication No. 2004-311925

### SUMMARY OF INVENTION

However, a FePt-containing magnetic layer is in a disordered phase with a face-centered cubic (FCC) structure and its crystal magnetic anisotropy is very small, for example, in a film formed state by sputtering. To enhance the crystal magnetic anisotropy, transformation into an ordered phase (L1o structure) is necessary. To obtain an L1o ordered phase, it is normally necessary to perform a high-temperature heat treatment exceeding 500° C. such as film formation on a preheated substrate or annealing of a disordered alloy thin film after film formation. There has been also a problem that, if a heat treatment is applied to obtain an L1o ordered phase after a granular film such as FePt—SiO₂ is formed, particles become coarse and only a granular film with an uneven particle size can be obtained. Thus, a case of success in forming a film with a size dispersion of FePt particles with an L1o structure having a diameter of 5 nanometers required for magnetic recording of 1 terabit per inch² suppressed to 15% or lower has not been reported yet.

A FePt alloy with an L1o structure is known to have large crystal magnetic anisotropy in its axis of easy magnetization (C-axis) and it is important to control the orientation of the C-axis of the L1o structure to improve the crystal magnetic anisotropy of a medium and obtain good magnetic properties. A method for forming a FePt-containing granular magnetic layer on an underlayer such as CrRu/MgO is known as prior art (J. S. Chen, B. C. Lim, J. F. Hu, Y. K. Lim, B. Liu and G. M. Chow, Appl. Phys. Lett., 90, 042508 (2007)). The study of the present inventors revealed that the crystal orientation of an underlayer such as the above MgO-containing underlayer was insufficient to attain desired properties, for example, for magnetic recording media with an ultra-high recording density beyond 1 terabit per inch². According to the speculation of the present inventors, if the crystal orientation of the underlayer is insufficient, it is thought to affect the crystal orientation of a magnetic layer right above, resulting in deterioration in the magnetic properties and recording/reproducing characteristics of the medium.

Since a FePt-containing material has a high Ku, thermal stability is maintained even if magnetic particles are refined. However, according to the study of the present inventors, in the case of a FePt alloy with an L1o structure, Ku is reduced below the order of 10⁷ and thermal stability becomes insufficient for magnetic recording media with an ultra-high recording density beyond 1 terabit per inch² if particle size is made smaller for a higher recording density.

As described above, the FePt-containing magnetic material normally requires a high-temperature heat treatment exceeding 500° C. to obtain an L1o ordered structure. However, in the case of performing such a high-temperature annealing process, amorphous materials such as CoTaZr and FeCoTaZr which are soft magnetic materials of conventional perpendicular magnetic recording media are crystallized, which results in deterioration of soft magnetic properties and an increase in surface roughness. Therefore, it is difficult to use the conventional soft magnetic materials and the FePt-containing magnetic material in combination. It is conventionally known to reduce an annealing temperature by adding Ag to a FePt-containing magnetic material with a non-granular structure. If the annealing temperature is simply reduced, then a problem of being unable to satisfactorily obtain the L1o ordered structure arises.

In short, the use of the FePt-containing magnetic material is very preferable in realizing a magnetic recording medium with an ultra-high recording density exceeding the information recording density of the present perpendicular magnetic recording media, but it has been conventionally difficult to make magnetic particle size smaller while maintaining a high Ku and obtain good magnetic properties (particularly optimization of coercivity (Hc) and magnetization reversal nucleation field (Hn)) even if the annealing temperature is reduced.

In view of such problems inherent in the prior art, the present invention aims to provide a perpendicular magnetic recording medium capable of dealing with an increase in ultra-high recording density and its manufacturing method.

The present inventors found out the following to complete the present invention as a result of a dedicated study to solve the above conventional problems. A perpendicular magnetic recording medium including at least a seed layer made of noncrystalline ceramic such as SiO₂, a crystalline orientation control layer made of, e.g. MgO and a magnetic layer made of a material mainly containing a FePt alloy in this order on a substrate can further improve crystal orientation and microstructure of the orientation control layer by providing the noncrystalline seed layer made of ceramic below the orientation control layer. As a result, it is possible to suppress a disturbance of crystal orientation of the magnetic layer made of the material mainly containing the FePt alloy, obtain a granular structure in which FePt ferromagnetic particles with an L1o structure having an average particle diameter of 8 nm or less are uniformly dispersed and further improve magnetic properties and recording and reproducing characteristics while maintaining a high Ku. In other words, the present invention has the following constructions to solve the above problems.

### (Construction 1)

A perpendicular magnetic recording medium used for information recording by a perpendicular magnetic recording method comprises at least a seed layer made of noncrystalline ceramic, a crystalline orientation control layer and a magnetic layer made of a material mainly containing a FePt alloy in this order on a substrate.

### (Construction 2)

In the perpendicular magnetic recording medium according to construction 1, the seed layer is made of a metal oxide.

### (Construction 3)

In the perpendicular magnetic recording medium according to construction 1 or 2, a lattice constant mismatch of the orientation control layer with FePt (001) with an L1o structure is 10% or less.

### (Construction 4)

In the perpendicular magnetic recording medium according to any one of constructions 1 to 3, the magnetic layer is a ferromagnetic layer with a granular structure including crystal particles mainly containing the FePt alloy with the L1o structure and a grain boundary portion mainly containing a nonmagnetic substance.

### (Construction 5)

In the perpendicular magnetic recording medium according to any one of constructions 1 to 4, a soft magnetic layer containing at least Fe, at least one element selected from Ta, Hf and Zr and at least one element selected from C and N is provided between the substrate and the seed layer.

### (Construction 6)

A perpendicular magnetic recording medium manufacturing method comprises a step of forming at least a seed layer made of noncrystalline ceramic, a crystalline orientation control layer and a magnetic layer made of a material mainly containing a FePt alloy in this order on a substrate by sputtering, wherein the magnetic layer is formed at a predetermined temperature of 500° C. or less.

### (Construction 7)

In the perpendicular magnetic recording medium manufacturing method according to construction 6, the magnetic layer is formed at a predetermined temperature of 400° C. or less, and the substrate is annealed at 500° C. or less after the magnetic layer is formed.

The seed layer is made of, e.g. an oxide of silicon and the orientation control layer is made of, e.g. an oxide of magnesium.

Further, the magnetic layer mainly containing the FePt alloy may contain an element having a solid solubility limit of below 1 atomic % with Fe at a room temperature. At least one element selected, for example, from Ag, Cu, B, Ir, Sn, Pb, Sb, Bi and Zr may be contained as such an element. Further, the magnetic layer may contain at least one element selected, for example, from C, P and B.

Further, the soft magnetic layer between the substrate and the seed layer may contain C or N.

Further, in the perpendicular magnetic recording medium manufacturing method of the present invention, a substrate heating temperature after the formation of the magnetic layer may be set at 500° or less and an annealing process performed after the formation of the magnetic layer if necessary may be performed at 500° C. or less.

Since the perpendicular magnetic recording medium of the present invention comprises at least the seed layer made of noncrystalline ceramic, the crystalline orientation control layer and the magnetic layer made of the material mainly containing the FePt alloy in this order on the substrate, crystal orientation and microstructure of the orientation control layer can be further improved by providing the seed layer made of noncrystalline ceramic below the orientation control layer as a layer below the magnetic layer, with the result that it is possible to suppress a disturbance of crystal orientation of the magnetic layer made of the material mainly containing the FePt alloy, obtain a granular structure in which FePt ferromagnetic particles with an L1o structure having an average particle diameter of 8 nm or less are uniformly dispersed and further improve magnetic properties (particularly optimization of coercivity (Hc) and magnetization reversal nucleation field (Hn)) and recording and reproducing characteristics while maintaining a high Ku. Thus, it is possible to obtain a perpendicular magnetic recording medium capable of dealing with an increase in ultra-high recording density. Further, according to the perpendicular magnetic recording medium of the present invention, it is possible to make magnetic particle size smaller while maintaining a high Ku and, hence, obtain good magnetic properties (particularly high Hn).

Further, the perpendicular magnetic recording medium manufacturing method of the present invention can form a good granular structure in which FePt ferromagnetic particles with an L1o structure are uniformly dispersed and is suitable for manufacturing a perpendicular magnetic recording medium capable of dealing with an ultra-high recording density and having good magnetic properties.

### BRIEF DESCRIPTION OF DRAWINGS

FIG. 1 is a diagram showing a TEM image and particle dispersion in a plane of a FePt granular magnetic thin film in Example 1,

FIG. 2 is a graph showing X-ray diffraction patterns of FePt granular magnetic thin films in Example 1,

FIG. 3 is a graph showing magnetization curves of the FePt granular magnetic thin film in Example 1,

FIG. 4 is a graph showing an X-ray diffraction pattern of a FePt granular magnetic thin film in Comparative Example 1,

FIG. 5 is a graph showing an X-ray diffraction pattern of a FePt granular magnetic thin film in Example 2,

FIG. 6 is a graph showing magnetization curves before and after an annealing process in Example 3,

FIG. 7 is a graph showing magnetization curves before and after an annealing process in Comparative Example 2,

### DESCRIPTION OF EMBODIMENTS

Hereinafter, one embodiment of the present invention is described in detail.

The present invention is directed to a perpendicular magnetic recording medium used for information recording by a perpendicular recording method, wherein at least a seed layer made of noncrystalline ceramic, a crystalline orientation control layer and a magnetic layer made of a material mainly containing a FePt alloy are provided in this order on a substrate as in Construction 1.

In the present invention, it is preferable to provide a soft magnetic layer between the substrate and the seed layer.

A layer construction in which an adhesion layer, a soft magnetic layer, a seed layer, an orientation control layer, a magnetic layer (perpendicular magnetic recording layer) and the like are successively laminated on a substrate in this order from the one closest to the substrate is specifically given as one embodiment of a layer construction of the above perpendicular magnetic recording medium according to the present invention (perpendicular magnetic recording disk).

A glass substrate is preferably used as the above substrate. Aluminosilicate glass, aluminoborosilicate glass, soda-lime glass and other glasses are usable as glass for the substrate. Among them, aluminosilicate glass is preferable. It is also possible to use amorphous glass or crystallized glass. The use of chemically strengthened glass is preferable because of high rigidity. In the present invention, the surface roughness of a main surface of the substrate is 10 nm or less in Rmax and 0.3 nm or less in Ra.

A soft magnetic layer for suitably adjusting a magnetic circuit of the perpendicular magnetic recording layer is preferably provided on the substrate. Such a soft magnetic layer is preferably formed to include AFC (antiferromagnetic exchange coupling) by interposing a nonmagnetic spacer layer between a first soft magnetic layer and a second soft magnetic layer. This enables directions of magnetization of the first and second soft magnetic layers to be aligned and fixed in an antiparallel manner with high accuracy, whereby noise produced from the soft magnetic layer can be reduced. For example, FeTa-containing materials such as FeTaC and FeTaN and Co-and CoFe-containing materials such as CoTaZr, CoFeTaZr and CoFeTaZrAlCr can be used to constitute the first and second soft magnetic layers. In the present invention, a material which can be crystallized (nano-crystallized) at the time of a heat treatment to maintain soft magnetic properties is preferably used as the material of the soft magnetic layer, and the soft magnetic layer preferably contains at least Fe, at least one element selected from Ta, Hf and Zr and at least one element selected from C and N.

Note that the FeTa-containing materials are preferable since their soft magnetic properties are improved by the heat treatment. Further, the FeTa-containing materials are preferable since their soft magnetic properties are further improved by further containing C or N.

The above spacer layer may be made of, for example, Ru (Ruthenium) or Ru-alloy. An additive element for controlling an exchange coupling constant may be mixed.

The film thickness of the soft magnetic layer is preferably 15 nm to 200 nm as a whole although it differs depending on the structure of the soft magnetic layer and the structure and characteristics of a magnetic head. The thicknesses of the respective upper and lower layers are preferably substantially equal although they may be made slightly different to optimize recording and reproduction.

It is also preferable to form an adhesion layer between the substrate and the soft magnetic layer. Since an adhesive property between the substrate and the soft magnetic layer can be improved by forming the adhesion layer, detachment of the soft magnetic layer can be prevented. For example, a Ti-containing material may be used as the material of the adhesion layer.

The seed layer has a function of controlling (improving) orientation, crystallinity and microstructure of crystal particles of the orientation control layer located above.

In the present invention, the seed layer is made of a noncrystalline ceramic material. The material of such a seed layer may be selected, for example, from Si, Al and the like or maybe selected from oxides (oxygen-containing ceramics) in which these elements are combined with oxygen. For example, noncrystalline SiO₂, Al₂O₃ or the like may be favorably selected. The film thickness of the seed layer is preferably minimum necessary to control crystal growth of the orientation control layer located above.

The orientation control layer is, coupled with functions and effects of the seed layer, used to suitably control perpendicular orientation of an axis of easy magnetization of an L1o crystal structure in a magnetic layer (perpendicular magnetic recording layer) made of a material mainly containing a FePt alloy (crystal is oriented in a direction perpendicular to a substrate surface), uniform reduction of a crystal particle diameter, grain boundary segregation in the case of forming a granular structure, etc. Such an orientation control layer is, for example, made of only Mg or MgAl alloy, but there is no limitation to it. In the present invention, MgO, MgAl₂O₄, CrRu, AlRu, Pt, Cr and the like are specifically preferably used as the material of the orientation control layer, but there is no limitation to them. In the present invention, it is particularly preferable that a lattice constant mismatch of the orientation control layer with FePt (001) of the L1o structure in the magnetic layer located above is 10% or less. By setting the lattice mismatch with FePt in the magnetic layer in the above range, a disturbance of crystal orientation of the FePt magnetic layer by the orientation control layer is suppressed and an effect of improving the microstructure is satisfactorily exhibited.

In the present invention, the orientation control layer may be composed of a single layer or a plurality of layers. In the case of a plurality of layers, it is possible not only to combine layers of the same material, but also to combine layers of different materials.

The film thickness of the orientation control layer needs not particularly be limited, but is preferably minimum necessary to control the structure of the perpendicular magnetic recording layer and, for example, appropriately lies in a range of about 5 to 30 nm as a whole.

The magnetic layer (perpendicular magnetic recording layer) is made of a material mainly containing a FePt alloy. Since the FePt alloy has a high crystal magnetic anisotropy constant (Ku) and ensures thermal stability even if magnetic particles are refined, it is suitable for a higher recording density of the magnetic recording medium.

The magnetic layer preferably contains an element having a solid solubility limit of below 1 atomic % with Fe at a room temperature. At least one element selected, for example, from Ag, Cu, B, Ir, Sn, Pb, Sb, Bi and Zr is preferably contained as such an element. Since inclusion of an element such as Ag and Cu contributes to promotion of regularization of the L1o structure of FePt, an annealing temperature after the formation of the magnetic layer can be reduced more than before.

The magnetic layer preferably contains at least one element selected, for example, from C, P and B. By containing the element such as C, P or B, refinement of FePt magnetic particles can be promoted.

Accordingly, in the present invention, the magnetic layer particularly preferably contains at least one element selected from Ag and Cu and at least one element selected from C, P and B.

In the present invention, for an ultra-high recording density of the medium, the magnetic layer preferably includes a ferromagnetic layer with a granular structure (hereinafter, arbitrarily called “granular magnetic layer”) including crystal particles mainly containing the FePt alloy and a grain boundary portion mainly containing a nonmagnetic substance such as C, P, B or a metal oxide. Ferromagnetic materials such as FePt (iron-platinum) containing at least one nonmagnetic substance such as C (carbon), FePtAg(iron-platinum-silver), FePtCu (iron-platinum-copper) are preferably cited as a specific FePt-containing magnetic material constituting the above granular magnetic layer. Further, the film thickness of this granular magnetic layer is preferably, for example, 20 nm or less.

An auxiliary recording layer may be provided above or below the granular magnetic layer. By providing the auxiliary recording layer, high heat resistance can be added in addition to a high density recording characteristic and a low noise characteristic of the magnetic layer and a coercivity control. The auxiliary recording layer may be made of a FePt-containing ferromagnetic alloy, for example, with an Al structure. Instead of forming the ferromagnetic layer, it is also possible to control coercivity by making a part of the FePt magnetic material with the L1o structure disordered into the Al structure by ion irradiation or plasma damage.

Further, an exchange-coupling control layer may be provided between the granular magnetic layer and the auxiliary recording layer. By providing the exchange-coupling control layer, recording and reproducing characteristics can be optimized by suitably controlling the strength of exchange coupling between the granular magnetic layer and the auxiliary recording layer. The exchange-coupling control layer is, for example, suitably made of Ru or Ru alloy.

The perpendicular magnetic recording layer including the granular magnetic layer is preferably formed by sputtering. Particularly, DC magnetron sputtering is preferable since uniform film formation is possible. Further, RF sputtering may also be applied for the seed layer and the orientation control layer.

Further, a protection layer is preferably provided on the magnetic layer (perpendicular magnetic recording layer). By providing the protection layer, a surface of the magnetic recording medium can be protected from a magnetic head floating above the magnetic recording medium. For example, a carbon-containing protection layer is preferably used as the protection layer. Further, the film thickness of the protection layer is preferably about 3 to 7 nm. The protection layer may be formed, for example, by plasma CVD or sputtering.

A lubricant layer is preferably provided on the protection layer. By providing the lubricant layer, abrasion between the magnetic head and the magnetic recording medium can be suppressed and durability of the magnetic recording medium can be improved. For example, perfluoro polyether (PFPE)-containing compound is preferably used as the material of the lubricant layer. The lubricant layer maybe formed, for example, by dip coating.

The present invention also aims to provide a manufacturing method suitable for manufacturing the above perpendicular magnetic recording medium according to the present invention.

Specifically, the present invention is directed to a perpendicular magnetic recording medium manufacturing method comprising a step of forming at least a seed layer made of noncrystalline ceramic, a crystalline orientation control layer and a magnetic layer made of a material mainly containing a FePt alloy in this order on a substrate by sputtering, wherein the magnetic layer is formed at a predetermined temperature of 500° C. or less.

For example, in the case of the above one embodiment of the perpendicular magnetic recording medium, the adhesion layer, the soft magnetic layer, the seed layer, the orientation control layer and the like are successively formed on the substrate from the one closest to the substrate by sputtering, and the substrate is heated at the predetermined temperature of 500° C. or less after formation of the orientation control layer and before formation of the magnetic layer and then the magnetic layer is formed on the orientation control layer, whereby perpendicular orientation of the axis of easy magnetization of the L1o crystal structure in the magnetic layer (perpendicular magnetic recording layer) made of the material mainly containing the FePt alloy and microstructure (uniform refinement) of the crystal particle diameter are suitably controlled and a perpendicular magnetic recording medium having good magnetic properties (particularly optimization of coercivity (Hc) and magnetization reversal nucleation field (Hn)) and capable of dealing with an increase in ultra-high recording density can be obtained. Further, according to the perpendicular magnetic recording medium manufacturing method of the present invention, it is possible to make the magnetic particle size smaller while maintaining a high Ku and improve crystal orientation of the magnetic layer, wherefore good magnetic properties can be obtained.

Since it is important to form the magnetic layer at the predetermined temperature of 500° C. or less in the present invention, it is not essential to heat the substrate during the formation of the magnetic layer, for example, when a film forming rate of the magnetic layer is high and a reduction in the substrate temperature until the completion of the formation of the magnetic layer is small if the substrate is heated to the predetermined temperature of 500° C. or less before the magnetic layer is formed. On the other hand, when the film-forming rate of the magnetic layer is low and a reduction in the substrate temperature until the completion of the formation of the magnetic layer cannot be ignored even if the substrate is heated to the predetermined temperature of 500° C. or less before the magnetic layer is formed, it is preferable to heat the substrate also during the formation of the magnetic layer.

After the magnetic layer is formed, the substrate maybe heated if necessary (in the present invention, a heating process after the magnetic layer formation is particularly called “annealing process”). In the present invention, the annealing process in this case can be performed at an annealing temperature of 500° C. or less, which is lower than before. Since the annealing temperature can be lower than before, there is an advantage that amorphous materials such as CoTaZr and FeCoTaZr which are suitably used as soft granular magnetic layers of conventional perpendicular magnetic recording media can be also used in the present invention. In view of the case where the conventional soft granular magnetic layers are deteriorated by the heating process, it is also possible to use a nano-crystalline amorphous material whose soft magnetic properties are not deteriorated even by heating up to 600° C. such as Fe—TM—C (where TM=at least one element selected from Ta, Hf and Zr).

According to the study of the present inventors, a heating temperature at the time of forming the magnetic layer is preferably 500° C. or less, more preferably in a range of 350° C. to 500° C. in substrate surface temperature.

In the above perpendicular magnetic recording medium manufacturing method according to the present invention, the formation of the magnetic layer at the predetermined temperature of 500° C. or less further contributes to improvements in the perpendicular orientation and microstructure of the FePt magnetic layer formed on the orientation control layer and to a reduction in the annealing temperature after the formation of the magnetic layer in addition to the preferable effect of controlling the crystal orientation and microstructure of the FePt magnetic layer by the above seed layer and orientation control layer.

According to the study of the present inventors, since obtained Hn may not be sufficient when a substrate temperature at the time of forming the magnetic layer is 400° or less, it is desirable to perform the annealing process in such a case after the magnetic layer is formed and the annealing temperature is preferably 500° C. or less in substrate surface temperature.

The perpendicular magnetic recording medium according to the present invention is particularly preferable as a perpendicular magnetic recording disk to be loaded into a magnetic disk device such as an HDD. Also, it is particularly preferably used as a discrete track medium (DTM) or a bit patterned medium (BPM) expected to be a medium for realizing an ultra-high recording density further exceeding the information recording density of the present perpendicular magnetic recording media or a medium for thermally assisted recording capable of attaining an ultra-high recording density further exceeding the information recording density by the perpendicular magnetic recording method.

### EXAMPLES

Hereinafter, the embodiment of the present invention is more specifically described and functions and effects by the present invention are illustrated with respect to Examples and Comparative Examples.

### Example 1

A nonmagnetic and heat resistant disk-shaped glass substrate having a diameter of 65 mm was prepared, and a SiO₂ layer of 2 nm was formed as a seed layer on the glass substrate at a room temperature by sputtering. Note that the formed SiO₂ layer was amorphous (noncrystalline).

Here, the substrate having up to the seed layer formed thereon was heated to reach 100° C. (substrate surface temperature) in a chamber and a MgO layer of 10 nm was formed as an orientation control layer on the seed layer by sputtering.

Here, the substrate having up to the orientation control layer formed thereon was heated to reach 450° C. (substrate surface temperature) in the chamber and 50 (90 (50Fe-50Pt)-10Ag)-50C was formed as a granular magnetic layer (perpendicular magnetic recording layer) on the orientation control layer by sputtering. Note that the film thickness of the granular magnetic layer was changed in a range of 3 nm to 10 nm.

Perpendicular magnetic recording media of Example 1 were obtained by the above manufacturing process.

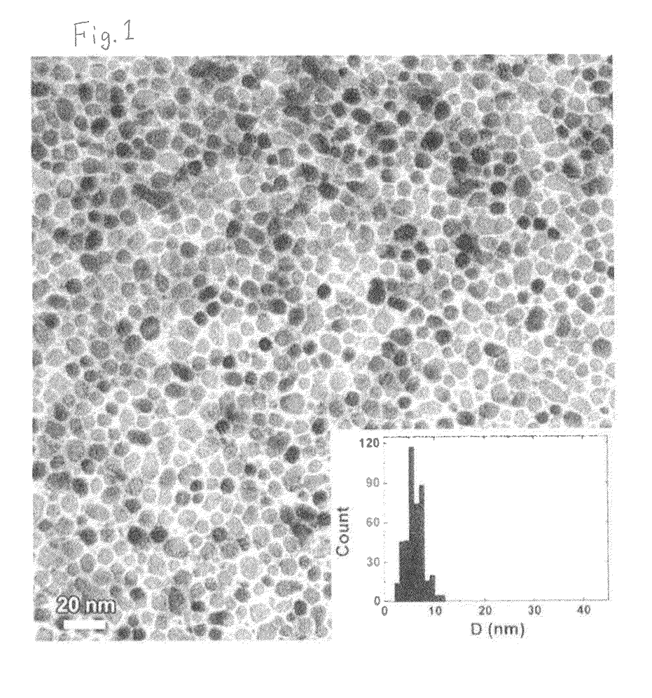

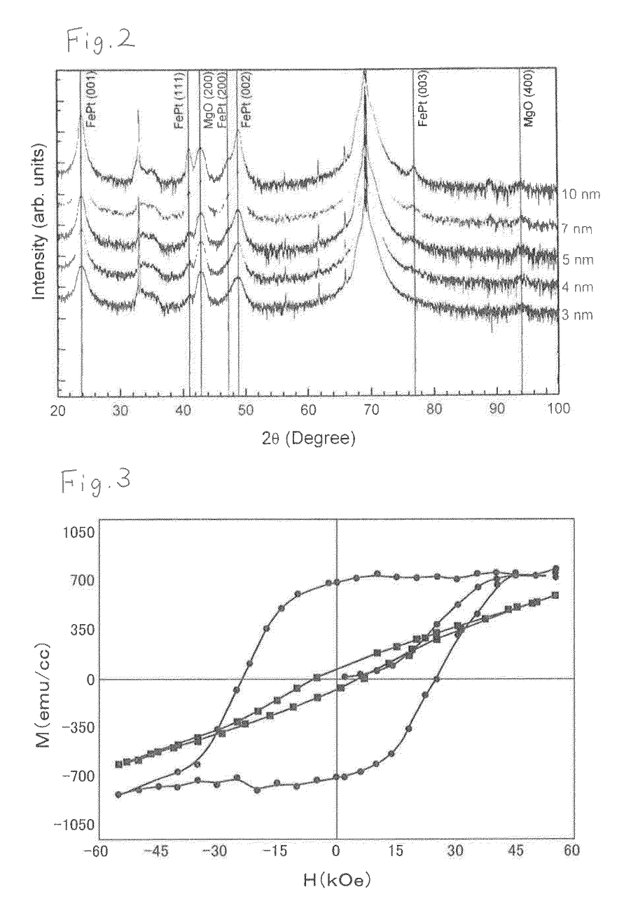

FIG. 1 shows a TEM image and particle dispersion in a plane of the above FePtAg—C granular magnetic thin film, FIG. 2 shows X-ray diffraction patterns, and FIG. 3 shows magnetization curves when the film thickness of the granular magnetic layer is 10 nm. Note that, in FIG. 3, curves plotting • are magnetization curves in a perpendicular direction and those plotting ▪ are magnetization curves in an in-plane direction.

The TEM image and the particle dispersion of FIG. 1 reveal that the FePtAg—C granular magnetic thin film of this Example has a good microscopic texture with an average particle diameter of about 6.5 nm and a particle dispersion of about 1.5 nm. Further, looking at the X-ray diffraction patterns of FIG. 2, it can be understood that MgO undergoes (001) growth as shown by a peak of MgO (200) near 43° of X-ray data and, as a result, FePt has high regularity and good vertical magnetic anisotropy can be obtained as shown by a FePt (001) peak near 24° of the X-ray data. Further, the magnetization curves of FIG. 3 show strong perpendicular magnetic anisotropy and a very high coercivity of about 24 kOe.

### Comparative Example 1

80Fe-8Ta-12C of 200 nm was formed as a soft magnetic layer on a glass substrate of Example 1 at a room temperature by sputtering.

Subsequently, the substrate having the soft magnetic layer formed thereon was heated to reach 100° C. (substrate surface temperature), and a MgO layer of 10 nm was formed as an orientation control layer on the soft magnetic layer by sputtering.

Subsequently, similar to Example 1, 50(90(50Fe-50Pt)-10Ag)-50C was formed as a granular magnetic layer (perpendicular magnetic recording layer) on the orientation control layer by sputtering.

A perpendicular magnetic recording medium of Comparative Example 1 was obtained by the above manufacturing process.

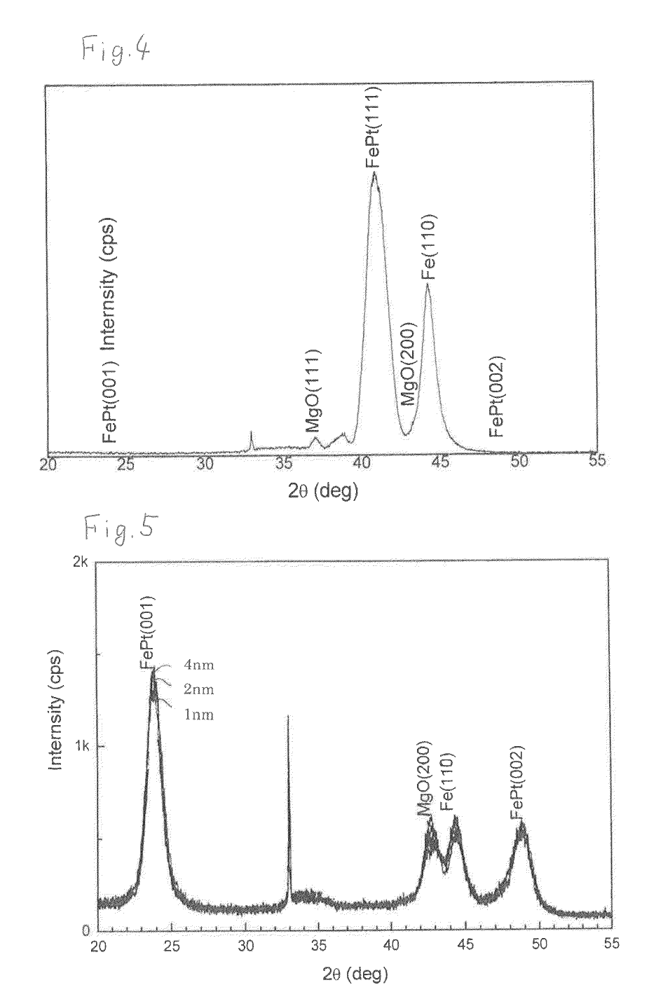

FIG. 4 shows an X-ray diffraction pattern of the FePtAg—C granular magnetic thin film in Comparative Example 1. It can be understood that if a MgO film is formed directly on a FeTaC soft magnetic film and a FePtAg—C granular film is formed on the MgO film, MgO undergoes (111) orientation without undergoing (001) growth, with the result that FePt undergoes (111) orientation and vertical magnetic anisotropy cannot be obtained.

### Example 2

80Fe-8Ta-12C of 200 nm was formed as a soft magnetic layer on a glass substrate of Example 1 at a room temperature by sputtering.

Subsequently, similar to Example 1, a SiO₂ layer as a seed layer, a MgO layer of 10 nm as an orientation control layer, and 50 (90 (50Fe-50Pt)-10Ag)-50C of 10 nm as a granular magnetic layer (perpendicular magnetic recording layer) were successively formed on the soft magnetic layer. Note that the film thickness of the seed layer was changed to three values of 1 nm, 2 nm and 4 nm.

Perpendicular magnetic recording media of Example 2 were obtained by the above manufacturing process.

FIG. 5 shows an X-ray diffraction pattern of the FePtAg—C granular magnetic thin film in Example 2. It can be understood that, by inserting the SiO₂ seed layer on the FeTaC soft magnetic film, MgO undergoes (001) orientation and, as a result, FePt undergoes (001) orientation. Note that Fe (110) in FIG. 5 is caused by the FeTaC soft magnetic film.

When a TEM image in a plane of the FePtAg—C granular magnetic thin film in this Example 2 was observed, it could be confirmed that a good granular microscopic texture was obtained as in Example 1 described above.

### Example 3

A perpendicular magnetic recording medium of Example 3 was obtained by a manufacturing process similar to that of Example 2 except that the substrate temperature at the time of forming the granular magnetic layer was 380° and the substrate having up to the granular magnetic layer formed thereon was annealed at 450° C. (substrate surface temperature) for 1 hour.

### Comparative Example 2

A perpendicular magnetic recording medium of Comparative Example 2 was obtained in a manner similar to Example 3 except for omitting the step of forming the seed layer made of SiO₂ in Example 3.

The respective perpendicular magnetic recording media of Example 3 and Comparative Example 2 were evaluated for static magnetic properties. For evaluation of static magnetic properties, the coercivity (Hc) and the magnetization reversal nucleation field (Hn) were measured using a Kerr effect measuring apparatus. As a result, Hc of the perpendicular magnetic recording medium of Example 3 was 80000e and Hn thereof was 44000e. On the other hand, Hc of the perpendicular magnetic recording medium of Comparative Example 2 was 49000e and Hn thereof was 10000e.

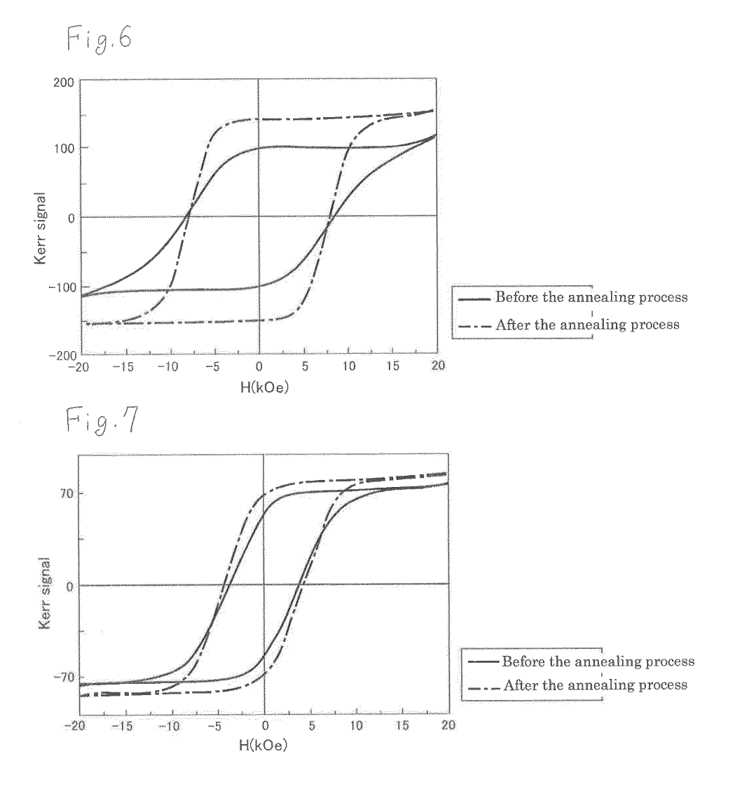

FIG. 6 shows magnetization curves before and after the annealing process in the perpendicular magnetic recording medium of Example 3. Solid line in FIG. 6 represents a hysteresis loop before the annealing process and dashed-dotted line represents a hysteresis loop after the annealing process. FIG. 7 shows magnetization curves before and after the annealing process in the perpendicular magnetic recording medium of Comparative Example 2, wherein solid line in FIG. 7 represents a hysteresis loop before the annealing process and dashed-dotted line represents a hysteresis loop after the annealing process.

From the above result, it was confirmed that, by including the seed layer made of noncrystalline ceramic (made of SiO₂ in Example 3) below the orientation control layer made of crystalline ceramic (made of MgO in Example 3) below the FePt granular magnetic layer with a high Ku, the perpendicular magnetic recording medium of Example 3 according to the present invention could have properties capable of dealing with an ultra higher recording density since it could have better magnetic properties (particularly Hn is high) as compared with the perpendicular magnetic recording medium of Comparative Example 2 including no such seed layer. It was also confirmed that the perpendicular magnetic recording medium of Example 3 according to the present invention could have good magnetic properties while maintaining a high Ku even if the annealing process after the formation of the FePt granular magnetic layer was performed at 500° C. or less, which was lower than before.

1. A perpendicular magnetic recording medium used for information recording by a perpendicular magnetic recording method, comprising at least a seed layer made of noncrystalline ceramic, a crystalline orientation control layer and a magnetic layer made of a material mainly containing a FePt alloy in this order on a substrate.

2. The perpendicular magnetic recording medium according to claim 1, wherein the seed layer is made of a metal oxide.

3. The perpendicular magnetic recording medium according to claim 1, wherein a lattice constant mismatch of the orientation control layer with FePt (001) with a L1o structure is 10% or less.

4. The perpendicular magnetic recording medium according to claim 1, wherein the magnetic layer is a ferromagnetic layer with a granular structure including crystal particles mainly containing the FePt alloy with the L1o structure and a grain boundary portion mainly containing a nonmagnetic substance.

5. The perpendicular magnetic recording medium according to claim 1, wherein a soft magnetic layer containing at least Fe, at least one element selected from Ta, Hf and Zr and at least one element selected from C and N is provided between the substrate and the seed layer.

6. A perpendicular magnetic recording medium manufacturing method, comprising a step of forming at least a seed layer made of noncrystalline ceramic, a crystalline orientation control layer and a magnetic layer made of a material mainly containing a FePt alloy in this order on a substrate by sputtering, wherein the magnetic layer is formed at a predetermined temperature of 500° C. or less.

7. The perpendicular magnetic recording medium manufacturing method according to claim 6, wherein the magnetic layer is formed at a predetermined temperature of 400° C. or less, and the substrate is annealed at 500° C. or less after the magnetic layer is formed.

8. The perpendicular magnetic recording medium according to claim 2, wherein a lattice constant mismatch of the orientation control layer with FePt (001) with a L1o structure is 10% or less.

9. The perpendicular magnetic recording medium according to claim 2, wherein the magnetic layer is a ferromagnetic layer with a granular structure including crystal particles mainly containing the FePt alloy with the L1o structure and a grain boundary portion mainly containing a nonmagnetic substance.

10. The perpendicular magnetic recording medium according to claim 3, wherein the magnetic layer is a ferromagnetic layer with a granular structure including crystal particles mainly containing the FePt alloy with the L1o structure and a grain boundary portion mainly containing a nonmagnetic substance.

11. The perpendicular magnetic recording medium according to claim 2, wherein a soft magnetic layer containing at least Fe, at least one element selected from Ta, Hf and Zr and at least one element selected from C and N is provided between the substrate and the seed layer.

12. The perpendicular magnetic recording medium according to claim 3, wherein a soft magnetic layer containing at least Fe, at least one element selected from Ta, Hf and Zr and at least one element selected from C and N is provided between the substrate and the seed layer.

13. The perpendicular magnetic recording medium according to claim 4, wherein a soft magnetic layer containing at least Fe, at least one element selected from Ta, Hf and Zr and at least one element selected from C and N is provided between the substrate and the seed layer.

14. The perpendicular magnetic recording medium according to claim 8, wherein a soft magnetic layer containing at least Fe, at least one element selected from Ta, Hf and Zr and at least one element selected from C and N is provided between the substrate and the seed layer.

15. The perpendicular magnetic recording medium according to claim 9, wherein a soft magnetic layer containing at least Fe, at least one element selected from Ta, Hf and Zr and at least one element selected from C and N is provided between the substrate and the seed layer.

16. The perpendicular magnetic recording medium according to claim 10, wherein a soft magnetic layer containing at least Fe, at least one element selected from Ta, Hf and Zr and at least one element selected from C and N is provided between the substrate and the seed layer.
